(19) United States
(12) Patent Application Publication
(10) Pub. No.: US 2014/0034722 A1
(43) Pub. Date: Feb. 6, 2014

(54) Method of Delivering Personalized Digital Events from a Single Scannable Two-Dimensional Barcode by Executing Computer-Executable Instructions Stored On a Non-Transitory Computer-Readable Medium

(71) Applicant: Lawrence Kwang HAN, Singapore (SG)

(72) Inventor: Lawrence Kwang HAN, Singapore (SG)

(21) Appl. No.: 13/956,058

(22) Filed: Jul. 31, 2013

Related U.S. Application Data
(60) Provisional application No. 61/678,416, filed on Aug. 1, 2012.

(51) Int. Cl. G06Q 30/02

(52) U.S. Cl. CPC G06Q 30/0271
USPC 235/375

(57) ABSTRACT

A method of delivering personalized digital events from a single scannable two-dimensional barcode by executing computer-executable instructions stored on a non-transitory computer-readable medium provides means for delivering personalized targeted advertising or other digital events to a user's smartphone by compiling user-entered personal attributes into a user profile and matching the user profile with one of several possible digital events.

The current application claims a priority to the U.S. Provisional Patent application Ser. No. 61/678,416 filed on Aug. 1, 2012.

### FIELD OF THE INVENTION

The present invention relates generally to applications for mobile electronic devices. More particularly, the present invention relates to a mobile device application for delivering personalized events from a single QR code.

### BACKGROUND OF THE INVENTION

Advertising is a form of communication for marketing and is used to encourage, persuade, or manipulate an audience (viewers, readers, or listeners) to continue an action or to take some new action. More commonly, the desired result is to drive consumer behavior with respect to commercial offering, although political and ideological advertising is also common. The purpose of advertising may also be to reassure employees or shareholders that a company is viable or successful.

Many methods of advertising exist, including wall painting, billboards, flyers, cinema and television advertisements, internet banners, bus stop benches, magazines, and newspapers. Some printed advertisements include a Quick Response code, or QR code, which is a two-dimensional barcode which records information in an array of pixels and which can be decoded with appropriate software. The QR code system was first designed for the automotive industry in Japan, but has become popular outside the automotive industry due to its fast readability and greater storage capacity compared to standard Universal Product Code (UPC) barcodes. A QR code consists of black square dots arranged in a square grid on a white background, which can be read by an imaging device, such as a camera, and processed using appropriate software until the image can be appropriately interpreted. Typical use of a QR code means scanning the QR code, after which data is extracted from patterns present in both horizontal and vertical components of the image. An event is triggered immediately after each successful decode. Events triggered by a QR code may include displaying a text message, downloading and displaying informative materials, playing video or music online, displaying contents of a website or interacting with another application, or other purposes.

Originally designed for industrial uses, QR codes have become common in consumer advertising. Typically, a smartphone or other mobile device such as a tablet is used as a QR-code scanner, displaying the code and converting it to some useful form (such as a standard URL for a website, thereby obviating the need for a user to type it manually into a web browser). In the shopping industry, knowing what causes the consumers to be motivated when approaching products by the use of QR codes, advertisers and marketers can use the behavior of scanning to get consumers to buy, causing it to have the best impact on ad and marketing design. As a result, the QR code has become a focus of advertising strategy, since it provides quick and effortless access to the brand's website. Beyond mere convenience to the consumer, the importance of this capability is that it increases the conversion rate (that is, increases the chance that contact with the advertisement will convert to a sale), by coaxing qualified prospects further down the conversion funnel without any delay or effort, bringing the viewer to the advertiser's site immediately, where a longer and more targeted sales pitch may continue.

Since many different kinds of people exist with widely varying interests, it is desirable to tailor advertisements to more closely identify with the individual traits of the people being advertised to. Traditionally, advertising has largely been relegated to static advertisements, such as an image printed in a newspaper or on a billboard. It is possible to create advertisements that dynamically reflect the interests of the viewer by previously gathering information about the viewer; however, some consumers value their privacy and do not want personal information revealed to companies.

The present invention is intended to be implemented as an application on a mobile device. Many mobile device applications exist which can read QR codes; however, existing applications may at-most act only as intermediaries to capture, store and post-process information remotely on internet servers.

With the present invention, individual information is contained within the user's mobile device while processed or recoded and unidentifiable information is used or relayed to trigger events. With this invention, the same QR code also allows different events to be triggered based on the different unidentifiable information relayed. The result is that a user can provide personal information which is useful in relaying personalized advertisements or other digital events, without disclosing the user's personal information.

### BRIEF DESCRIPTION OF THE DRAWINGS

FIG. 1 is a stepwise flow diagram of the overall process of the present invention.

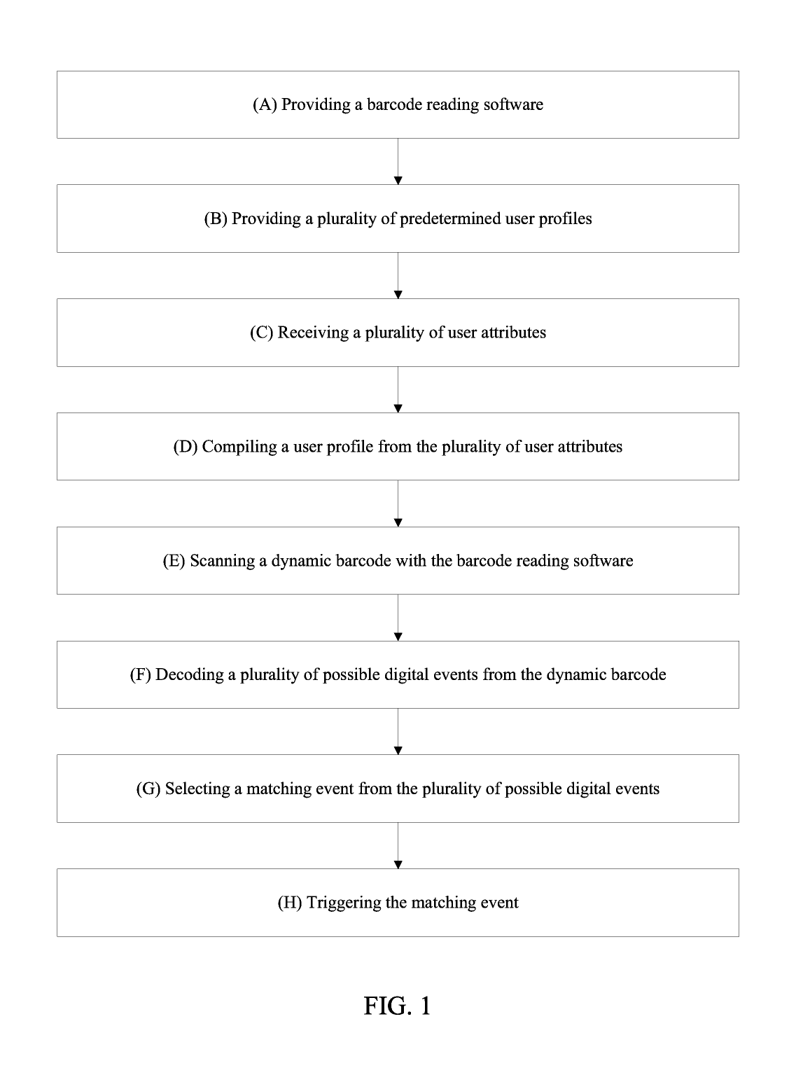

FIG. 2 is a stepwise flow diagram describing the process for compiling the user profile.

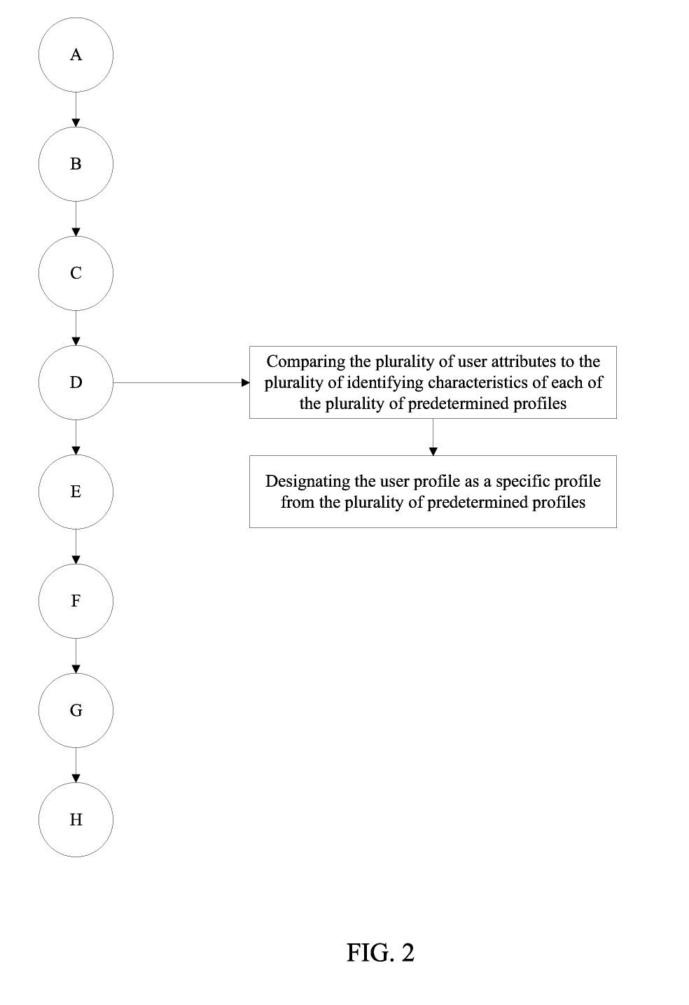

FIG. 3 is a stepwise flow diagram describing process for selecting the matching event.

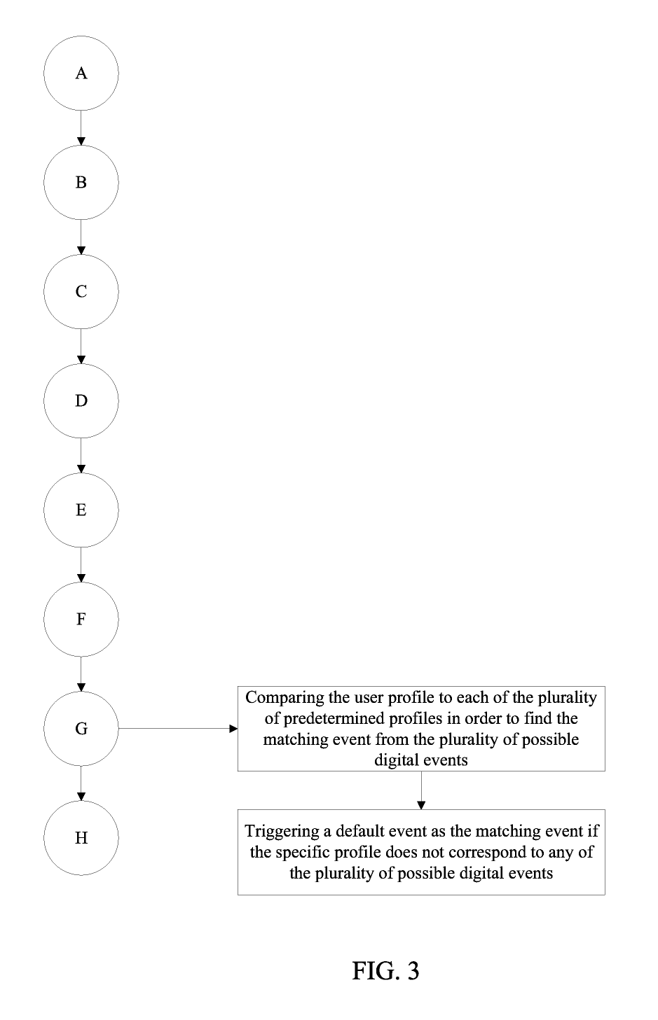

FIG. 4 is a stepwise flow diagram describing the process for triggering the matching event by requesting an event template from a web server.

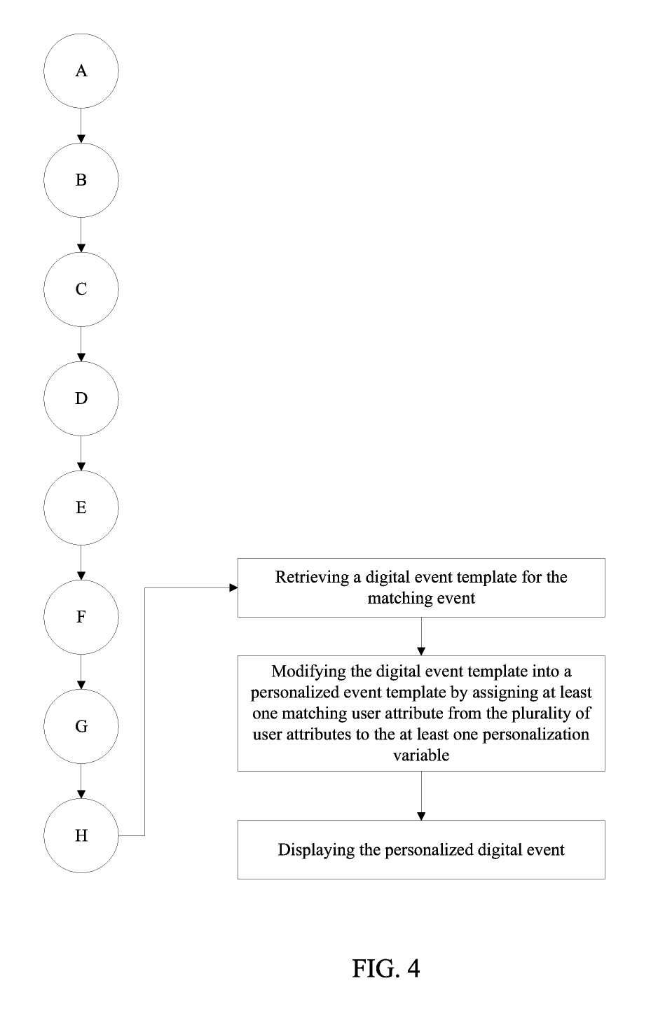

FIG. 5 is a stepwise flow diagram describing the process for triggering the matching event by sending the user's profile type to a web server.

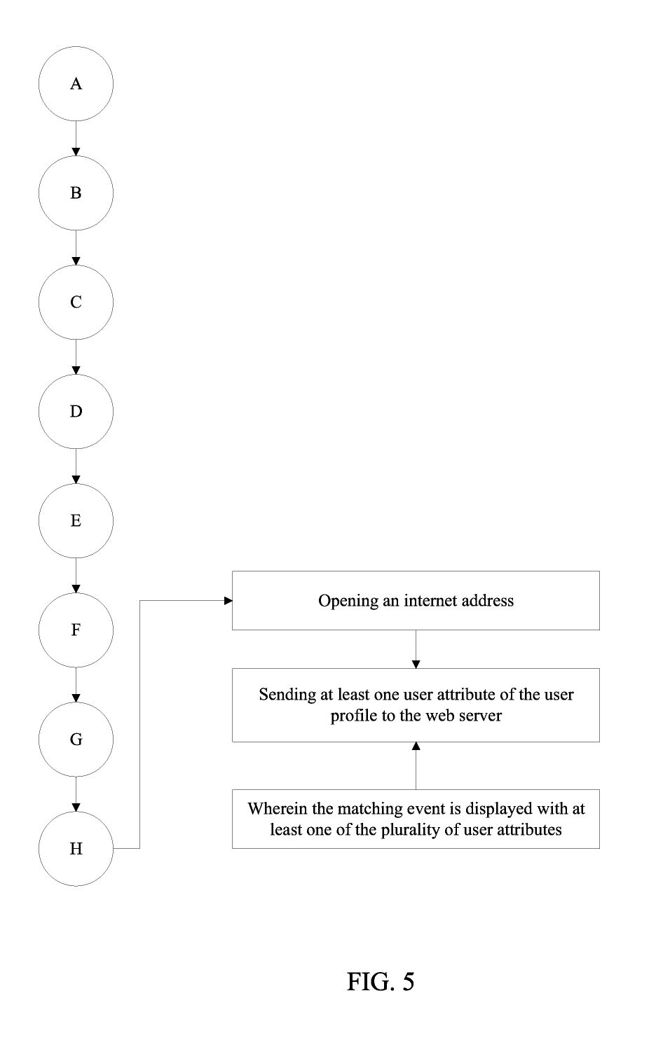

FIG. 6 is a stepwise flow diagram describing further steps for triggering the matching event.

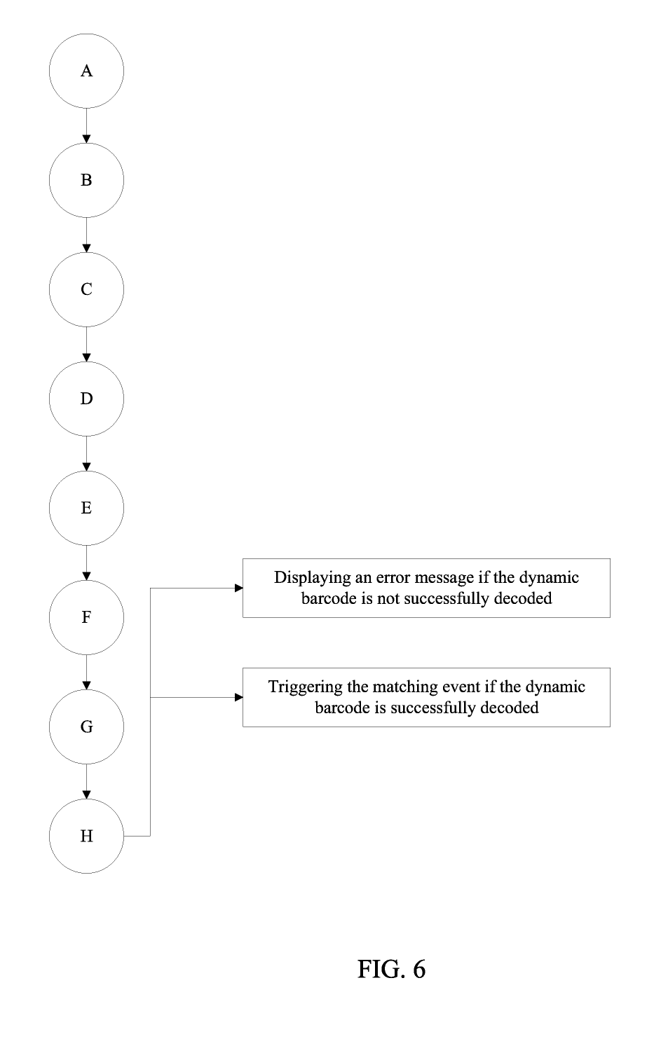

FIG. 7 is a stepwise flow diagram describing the general use of the present invention.

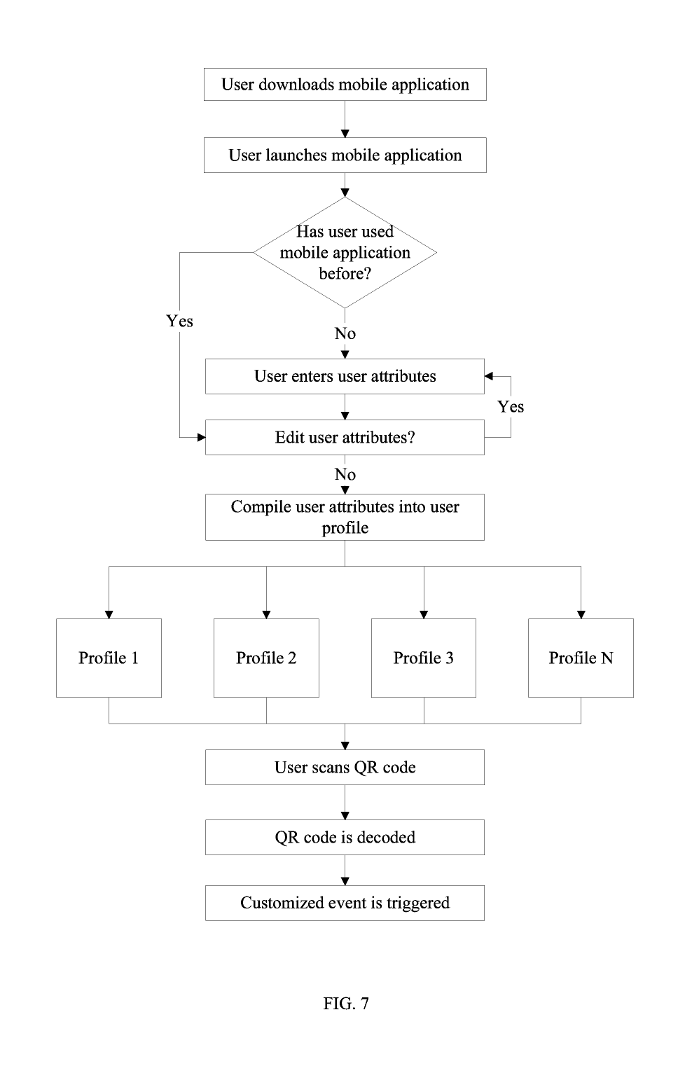

### DETAIL DESCRIPTIONS OF THE INVENTION

All illustrations of the drawings are for the purpose of describing selected versions of the present invention and are not intended to limit the scope of the present invention.

The object of the present invention is to provide targeted or personalized advertising or other personalized digital events to a user through the user's smartphone. The present invention is preferably embodied as an application or program on a smartphone, tablet or other mobile device. Hereinafter, it should be understood that “smartphone” may be interchanged with “tablet or other mobile device”. The goal of the present invention is to create a series of predetermined user profiles defined by specified user characteristics. As individual user install and use this application they will be categorized according to their characteristics into one of the predetermined user profiles.

The present invention is a method for delivering personalized digital events by scanning a single two-dimensional barcode. In the preferred embodiment of the present invention, the two-dimensional barcode is a Quick Response code, commonly known as a QR code. In the present invention, a single QR code provides the capability to deliver personalized or otherwise targeted advertisements, text messages or other digital events to a user's smartphone, whereas currently only one static digital event may be triggered by a QR code. In the preferred embodiment of the present invention, a smartphone application must be installed on a user's smartphone to utilize the present invention, and a dynamic QR code that has been enabled to provide multiple possible digital events must be provided in order to work with the present invention. In reference to the dynamic QR code, the “dynamic” qualifier is added because the dynamic QR code is capable of triggering one of multiple digital events (in conjunction with the present invention), whereas a traditional QR code may be thought of as static, as the traditional QR code is only able to trigger one event.

It should be noted that although the dynamic QR code is described as being dynamic, the dynamic QR code is not technically dynamic, because the dynamic QR code may initiate an event by calling a static website address with a variable incorporated into the address. For example, the dynamic QR code may call “www.abc123.com/x”, where x is a variable added by the smartphone application of the present invention, so strictly speaking the dynamic QR code is not itself necessarily functionally dynamic. To use the present invention, the user initiates the smartphone application, enters personal information into the smartphone application, and then scans a dynamic QR code with the smartphone application. The smartphone application processes the user's information, which it uses to determine which of the possible digital events to trigger. A triggered digital event may also be personalized to include one or more pieces of information about the user, such as but not limited to the user's name or gender.

In the preferred embodiment of the present invention, the overall process of the present invention is as follows. A barcode reading software is provided, wherein the barcode reading software is preferably capable of scanning traditional barcodes as well as QR codes. In one embodiment of the present invention, the barcode reading software is included in the smartphone application of the present invention. In an alternate embodiment, the barcode reading software is provided in a separate application on the user's smartphone, which the application of the present invention makes use of. In addition, a plurality of predetermined user profiles is provided, wherein each of the plurality of predetermined user profiles includes a plurality of identifying characteristics. In the preferred embodiment of the present invention, each of the plurality of predetermined profiles is different from each of the rest of the plurality of predetermined profiles. The plurality of predetermined profiles may be distinguished from each other by major characteristics, such as, but not limited to, gender, age, or relationship status, or other characteristics, such as, but not limited to, weight, height, school enrollment status, location, personality traits, food preferences, activity preferences, or other interests or traits.

A plurality of user attributes is received from a user, wherein each of the plurality of user attributes has an attribute type. After the user installs the smartphone app onto their smartphone, the user is provided with a plurality of user attribute fields, which the user fills in. The user may choose to not complete one or more user attribute fields. Alternatively, the smartphone application may not allow the user to continue without filling out one or more of the user attribute fields. A user profile is compiled from the plurality of user attributes, wherein the user profile is one of the plurality of predetermined user profiles. A dynamic barcode is then scanned with the barcode reading software, and a plurality of possible digital events is decoded from the dynamic barcode, wherein each of the plurality of possible digital events is associated with one of the plurality of predetermined user profiles. A matching event is selected from the plurality of possible digital events, wherein the matching event best matches the user profile. Once the matching event is selected, the matching event is then triggered. If the dynamic barcode is not successfully decoded, an error message is displayed. If the dynamic barcode is successfully decoded, the matching event is selected and triggered.

When compiling the user profile, the plurality of user attributes is compared to the plurality of identifying characteristics of each of the plurality of predetermined profiles.

The user profile is designated as a specific profile from the plurality of predetermined profiles, wherein the user attributes most closely match the identifying characteristics of the specific profile. For example, one of the plurality of predetermined profiles is defined for a female from Bulgaria between the age range of 18 to 24. If the user attributes of the user profile include being female, being between the age range of 18 to 24, and being from Bulgaria, and other important characteristics are matched, the user profile is designated as the specific profile, wherein the specific profile is a 18-24 year old female from Bulgaria as previously described. In one embodiment of the present invention, the user may select one or more of the plurality of user attributes to never share with outside sources. That is, in the case that in a digital event, an outside source requests one of the plurality of user attributes in order to personalize a digital event, the user may prevent the requested user attribute from being transmitted to the outside source.

When selecting the matching event, the user profile is compared to each of the plurality of predetermined user profiles associated with the plurality of possible digital events in order to find the matching event from the plurality of possible digital events. In this case, the matching event is associated with one of the plurality of predetermined user profiles, and one of the plurality of predetermined user profiles corresponds to the user profile. To explain further, the plurality of predetermined profiles is common to both the present invention in compiling the user profile, and to the plurality of possible digital events. The user profile is allocated to a specific one of the predetermined user profiles, and the matching digital event is allocated to the specific one of the predetermined user profiles. If the specific profile does not correspond to any of the plurality of possible digital events, a default event is triggered as the matching event.

In one embodiment of the present invention, a digital event template for the matching event is retrieved from an internet server. In the preferred embodiment of the present invention, in this case, the digital event template comprises at least one personalization variable, and each of the at least one personalization variable has an attribute type. The digital event template is then modified into a personalized digital event by assigning at least one matching user attribute from the plurality of user attributes to the at least one personalization variable, wherein the attribute type of the at least one matching user attribute matches the attribute type of the at least one personalization variable. For example, if the attribute type of the one of the at least one personalization variable is the user's name, the attribute type of the at least one matching user attribute is also the user's name. The personalized digital event is then displayed on the user's smartphone screen.

In another embodiment of the present invention, when the dynamic barcode is scanned, an internet address is opened by the user's smartphone, wherein the internet address is hosted by an internet server. At least one user attribute of the user profile is then sent to the web server, and the matching event is displayed by the web server on the user's smartphone screen, with the at least one user attribute being displayed with the matching event. For example, the at least one user attribute may be the user's name, and the matching event incorporates the user's name as part of the digital event. In this case, the user's name is displayed with the matching event instead of a generic message.

In the preferred embodiment of the present invention, the process of the user utilizing the present invention is as follows. It should be noted that the following description is simply an illustration of the preferred embodiment and is not intended to further limit the previous description. First, the user sees a QR code which the user desires to scan. In this case, the QR code is a dynamic QR code. The user takes out their smartphone, opens a typical QR code reader application, and scans the dynamic QR code. Once the dynamic QR code is decoded with the typical QR code reader application, the user is prompted to download the application of the present invention. If the user cancels the download, a default digital event is triggered. Otherwise, the user confirms the download, and the application of the present invention is downloaded to the user's smartphone. After the application of the present invention downloads and installs automatically, the application of the present invention launches and prompts the user to enter user attributes. At this point, if the user closes the application of the present invention, the default event is triggered. Otherwise, the user inputs the user attributes and clicks a “Save” button to confirm. The application of the present invention then compiles the user attributes into a profile code, and prompts the user to press a “See My Offer” button. When the user presses the “See My Offer” button, the application relays the profile code and a customized digital event is then triggered based on the profile code. After initial setup, the user may see another dynamic QR code. The user launches the application of the present invention and scans the dynamic QR code with a default QR code reader incorporated, or the user may launch a separate preferred QR code reader and scans the dynamic QR code. Once the QR code is read, the application of the present invention launches automatically (if the user used the separate preferred QR code reader) and prompts the user to press the “See My Offer” button. The user presses the “See My Offer” button, and the application of the present invention relays the profile code (which has already been compiled and saved), and a customized digital event is triggered based on the profile code.

Although the invention has been explained in relation to its preferred embodiment, it is to be understood that many other possible modifications and variations can be made without departing from the spirit and scope of the invention as hereinafter claimed.

What is claimed is:

1. A method of delivering personalized digital events from a single scannable two-dimensional barcode by executing computer-executable instructions stored on a non-transitory computer-readable medium comprises the steps of:
providing a barcode reading software;
providing a plurality of predetermined user profiles,
wherein each of the plurality of predetermined user profiles includes a plurality of identifying characteristics;
receiving a plurality of user attributes, wherein each of the plurality of user attributes has an attribute type;
compiling a user profile from the plurality of user attributes,
wherein the user profile is one of the plurality of predetermined user profiles;
scanning a dynamic barcode with the barcode reading software;
decoding a plurality of possible digital events from the dynamic barcode, wherein each of the plurality of possible digital events is associated with one of the plurality of predetermined user profiles;
selecting a matching event from the plurality of possible digital events, wherein the matching event best matches the user profile; and
triggering the matching event.

2. The method of delivering personalized digital events from a single scannable two-dimensional barcode by executing computer-executable instructions stored on a non-transitory computer-readable medium as claimed in claim 1 comprises the steps of:
comparing the plurality of user attributes to the plurality of identifying characteristics of each of the plurality of predetermined profiles; and
designating the user profile as a specific profile from the plurality of predetermined user profiles, wherein the user attributes most closely match the identifying characteristics of the specific profile.

3. The method of delivering personalized digital events from a single scannable two-dimensional barcode by executing computer-executable instructions stored on a non-transitory computer-readable medium as claimed in claim 1 comprises the step of:
comparing the user profile to each of the plurality of predetermined user profiles associated with the plurality of possible digital events in order to find the matching event from the plurality of possible digital events,
wherein the matching event is associated with one of the plurality of predetermined user profiles; and
wherein the one of the plurality of predetermined user profiles corresponds to the user profile.

4. The method of delivering personalized digital events from a single scannable two-dimensional barcode by executing computer-executable instructions stored on a non-transitory computer-readable medium as claimed in claim 3 comprises the step of:
triggering a default event as the matching event,
if the specific profile does not correspond to any of the plurality of possible digital events.

5. The method of delivering personalized digital events from a single scannable two-dimensional barcode by executing computer-executable instructions stored on a non-transitory computer-readable medium as claimed in claim 1 comprises the steps of:
retrieving a digital event template for the matching event,
wherein the digital event template comprises at least one personalization variable;
wherein each of the at least one personalization variable has an attribute type;
modifying the digital event template into a personalized digital event by assigning at least one matching user attribute from the plurality of user attributes to the at least one personalization variable, wherein the attribute type of the at least one matching user attribute matches the attribute type of the at least one personalization variable; and
displaying the personalized digital event.

6. The method of delivering personalized digital events from a single scannable two-dimensional barcode by executing computer-executable instructions stored on a non-transitory computer-readable medium as claimed in claim 1 comprises the step of:
opening an internet address, wherein the internet address is hosted by an internet server;
sending at least one user attribute of the user profile to the web server,
wherein the matching event is displayed by the web server; and
wherein the matching event is displayed with at least one of the plurality of user attributes.

7. The method of delivering personalized digital events from a single scannable two-dimensional barcode by executing computer-executable instructions stored on a non-transitory computer-readable medium as claimed in claim 1 comprises the steps of:
displaying an error message,
if the dynamic barcode is not successfully decoded; and
triggering the matching event,
if the dynamic barcode is successfully decoded.
